(19) United States
(12) Patent Application Publication
(10) Pub. No.: US 2004/0255039 A1
(43) Pub. Date: Dec. 16, 2004

(54) Method, system and network element device for controlling sessions between terminals

(76) Inventor: Bernard Honeisen, Bettwiesen (CH)

Correspondence Address: Robert M Bauer, Brown Raysman Millstein Felder & Steiner, 900 Third Avenue, New York, NY, 10022, US

(21) Appl. No.: 10/477,541

(22) PCT Filed: May 10, 2001
(86) PCT No.: PCT/EP01/05358

(51) Int. Cl. G06F 15/16

(52) U.S. Cl. 709/230

(57) ABSTRACT

The invention relates to a method, a system and a device for controlling sessions between terminals in a network by means of SIP for initiating, maintaining and terminating sessions with the terminals, thereby creating a SIP interdependency between a first and a second terminal. In order to increase the reliability in such networks, the SIP interdependency is created by establishing a first SIP relation between the first terminal and a network element, and a second SIP relation between the second terminal and a network element.

### FIELD OF THE INVENTION

The present invention relates to a method, a system and a network element device for controlling sessions between terminals in a network by means of a session initiation protocol being defined to initiate, maintain and terminate sessions with said terminals.

### BACKGROUND OF THE INVENTION

In 3GPP (3rd Generation Partnership Project) as UMTS (Universal Mobile Telecommunications System) SIP (Session Initiation Protocol) is used to establish multimedia sessions or calls, e.g. VoIP (Voice over Internet Protocol) sessions. A multimedia session is generally defined as a set of multimedia senders and receivers whereby data streams flowing from sender to receiver. Multimedia sessions include Internet multimedia conferences, internet telephone calls and multimedia distribution.

The session initiation protocol is a request-response control (signaling) protocol for initiating, maintaining and terminating sessions with one or more participants (senders and receivers) or terminal devices. The session initiation protocol is an application level protocol which is used in packet switched environments, e.g. GPRS (General Packet Radio Service) systems, UMTS or packet cable (USA cable modem standard) systems. The session initiation protocol can be used in any reliable or unreliable protocol, including UDP (User Datagram Protocol), SCTP (Stream Control Transmission Protocol) and TCP (Transmission Control Protocol).

The session initiation protocol uses session initiation messages to negotiate between participants or terminal devices. Thereby, a relation or interdependency on session initiation protocol level between terminals is established.

In a SIP session it may occur that a terminal, in particular a mobile terminal is not always in connection with the network. Such missing connections can result from temporary lost coverage of the radio network.

Furthermore, SIP messages sent from a terminal can be wrong either on purpose or due to a bug in an implementation. Consequently, it cannot be relied on a terminal, in particular on a mobile terminal, especially since a network provider does not have full control over the terminals connected to the network. As a result it cannot be ensured that a call identification is globally unique.

### SUMMARY OF THE INVENTION

It is therefore an object of the present invention to improve the reliability on terminals in a network.

This object is achieved by a method for controlling sessions between terminals in a network by means of a session initiation protocol being defined to initiate, maintain and terminate sessions with said terminals, thereby creating a session initiation protocol interdependency between a first terminal and a second terminal, said session initiation protocol interdependency being created by: establishing a first session initiation protocol relation between said first terminal and a network element currently associated with said first terminal, and establishing a second session initiation protocol relation between said second terminal and a network element currently associated with said second terminal.

Furthermore, the above object is achieved by a system comprising a one or more network elements and terminals, said system being designed for controlling sessions between said terminals by means of a session initiation protocol being defined to initiate, maintain and terminate sessions with said terminals, said system further comprising a session initiation protocol interdependency between a first terminal and a second terminal, said session initiation protocol interdependency comprising: a first session initiation protocol relation between said first terminal and a network element currently associated with said first terminal, and a second session initiation protocol relation between said second terminal and a network element currently associated with said second terminal.

Furthermore, the above object is achieved by a network element device for use in such a system and for controlling sessions between terminals in a network by means of session initiation protocol being defined to initiate, maintain and terminate sessions with said terminals and creating a session initiation protocol interdependency between a first terminal and a second terminal, said network element device comprising: first means for establishing a first session initiation protocol relation with said first terminal, and second means for establishing a second initiation protocol relation with a second terminal or a still further network element device.

The main idea of the invention is to divide an end-to-end session initiation protocol relation between two terminals into a number of session initiation protocol relations: a first session initiation protocol relation between a first terminal and a network element currently associated with the first terminal, and a second session initiation protocol relation between said second terminal and a network element currently associated with said second terminal.

The first session initiation protocol relation as well as the second session initiation protocol relation each represent a user-to-network interface (UNI) from the session initiation protocol point of view. In the 3GPP session initiation protocol such a user-to-network interface represents one hop, namely from a terminal to a network element or vice-versa.

Preferably, a third second session initiation protocol relation between said first network element and said second network element represents a network-to-network interface (NNI). In 3GPP session initiation protocol the NNI represents all hops between the network elements. Thereby, more than one operator's network can be involved, depending on a roaming scenario. In 3GPP session initiation protocol NNI represents all the session initiation protocol hops between call state control functions (CSCF), in particular proxy-CSCF (P-CSCF) interrogating-CSCF (I-CSCF) and serving-CSCF (S-CSCF), and application servers. Thereby, a call state control function is defined as a network element or can be comprised in a network element in 3GPP SIP, which performs certain session initiation protocol actions.

A “proxy-CSCF” is characterized as follows: It behaves like a proxy. That means that the proxy-CSCF accepts requests and services internally or forwards them on, possibly after translation. The proxy-CSCF can also behave as a user agent. That means that in abnormal conditions it may terminate and interdependently generate session initiation protocol transactions.

A “user agent” is defined as follows: A user agent is an application which can act both as a user agent client and as a user agent server. Thereby a user agent client is defined as a client application that initiates a session initiation protocol request. Furthermore, a user agent server is defined as a server application that contacts the user when a session initiation protocol request is received and that returns a response on behalf of the user. The response accepts, rejects or redirects the request.

An “interrogating-CSCF” is defined as the contact point within an operators network for all connections destined to a subscriber of that network operator, or a roaming subscriber currently located within that network operator's service area. There may be multiple interrogating-CSCFs within an operator's network.

A “serving-CSCF” is defined as follows: It performs a session control service for a user equipment. The serving-CSCF maintains a session state as needed by the network operator for support of the services. Within an operator's network different serving-CSCFs may have different functionalities.

Further details maybe taken from “3rd Generation Partnership Project; Technical Specification Group Services and Systems Aspects; IP Multimedia (IM) Subsystem—Stage 2 (3G TS 23.228 Version 5.0.0.)”, ETSI, which is incorporated herein by reference.

Furthermore, a “SIP relation” is understood as an end-to-end SIP association from one user agent to another user agent. A sending party in a network sends a SIP message that is forwarded to a receiving party, possibly after being routed via network elements that may amend a message header by inserting certain header fields, deleting certain header fields or modifying existing header fields. Thus, SIP messages belonging to different SIP relations are in general different from each other. It is noted that there are restrictions about which header fields can be inserted, modified or deleted. Such restrictions are described in RFC2543bis or other documents, e.g. describing certain SIP extensions.

A SIP relation can be taken as a “call leg” that can be defined as follows:

A “call leg” is identified by the combination of a call identification header field and an addr-spec and tag of the “To” and “From” header fields. Within the same call identification, request with “From A” and “To value B” belong to the same call leg as the request in the opposite direction, i. e. “From B” and “To A”.

Furthermore, a “SIP interdependency” is understood as the interaction between two or more parties in a network on SIP level, e.g. between a sender and recipient of a SIP message. However, the recipient either receives the SIP message generated from the sender, possibly with certain modifications carried out during routing the message through the network, or receives a new SIP message generated from a network element based on the SIP message received from this network element instead of the SIP message send from the sender.

It is proposed to separate the user-to-network interface and the network-to-network interface from the SIP point of view. Thus, the proxy-CSCF is no longer a typical SIP proxy but a new network element that can be called a pseudo-proxy. The pseudo-proxy acts as a user agent towards the terminal on one side and towards the interrogating-CSCF or serving-CSCF on the other side. For example, an outgoing proxy-CSCF acts as a user agent server towards the terminal and as a user agent client towards the core network.

This pseudo-proxy can also be understood as THE user agent of the terminal—with the special case that the protocol between the user agent and the terminal is also the session initiation protocol. Furthermore, the pseudo-proxy can be taken as a special gateway, namely as a SIP-to-SIP gateway.

The invention increases the reliability on terminals in a network, in the sense that session initiation protocol messages are assumed to be correct. As mentioned above, such session initiation protocol messages can be wrong, in particular either on purpose or due to a bug in an implementation. As according to the invention session initiation protocol messages can be relied on, routing in general gets easier, in particular with regard to session initiation protocol messages, which appear on the network-to-network interface.

Furthermore, it is noted that in the session initiation protocol only user agents are allowed to issue requests, such as INVITE and BYE requests. In mobile environment the connection to mobile terminals can get lost during a session. However, the call-leg still exists in the network and has to be released. The invention allows to facilitate this release.

Another advantage of the invention is the policy enforcement: If a paying party runs out of credit, in particular as it may occur in connection with prepaid solutions, the network has to release the corresponding session. For this release a trusted network element is needed. As the invention provides a trusted network element, the policy enforcement gets much easier.

Furthermore, due to the invention it is easier to connect a terminal to an announcement without (re-)negotiation of the session parameters with the terminal directly, but with the proxy-CSCF only. This saves capacity on the air-interface and makes switchovers, e.g. between announcement and called party faster and easier.

Furthermore, the invention allows the hiding of internal network structures from the terminals. This is i.a. performed by storing header fiels in the proxy-CSCF and not routing them towards the terminals. This safes capacity on the air-interface and in the terminal. This header fields contain information as the Via, Route and Record-Route header fields. Due to the invention it is fairly easy to prevent any header information going through the user-to-network interface to the terminal since these header fields are simply not used in the user-to-network interface, with the exception of the Via-header field, which contains the address of the proxy-CSCF.

It is noted, that the invention only requires to modify network elements, in particular the proxy-CSCF with regard to common SIP related networks. In particular the terminals may remain unchanged, thus allowing compatibility to existing systems.

Preferably, the network elements are altering call identifications of session initiation protocol messages. Thus, a first call identification is used in the first session initiation protocol relation, a second call identification is used the second session initiation protocol relation, and a third call identification is used in a third session initiation protocol relation. Thereby, preferably, first, second and third call identifications differ from each other. Thus, it can be assured that the call identification is globally unique in the network. This is advantageous with regard to charging purposes.

Also SIP security can be built up easier, as the security relations match the SIP relations. A possible security architecture could look like: one security association is made between the first terminal and the first network element, e.g. a first P-CSCF, an other between the first network element and the second network element, e.g. a second P-CSCF, and a third between the second network element and the second terminal.

Session timers can be used to check, whether all network elements and terminals in a chain are still working. Thus, it is used to detect failures or outages of network elements or terminals. In SIP a session timer can be implemented with sending SIP INVITE messages, which are the same as the last SIP INVITE message of the same session, but with increased CSeq number. If a session timer is used, it is desirable to use it only either on NNI or on UNI, e.g. to save bandwidth on the air interface. In addition, there are other means to detect a lost coverage. With this invention, a session timer only between P-CSCF A and P-CSCF B is in particular implementable the normal SIP way, as described above.

Further advantageous developments are defined in the dependent claims.

### BRIEF DESCRIPTION OF THE DRAWINGS

In the following, the present invention will be described in greater detail based on preferred embodiments with reference to the accompanying drawings, in which:

FIG. 1 shows a diagram of a network system including two mobile terminals being in progress of initiating a SIP session according to the prior art;

FIG. 2 shows a diagram of a network system including two mobile terminals being in progress of initiating a SIP session according to a preferred embodiment of the present invention;

FIG. 3a to 3e show the header fields from a SIP INVITE message routed from mobile terminal A to mobile terminal B as shown in FIG. 1;

FIG. 4a to 4e show the header fields from a SIP INVITE message routed from mobile terminal A to mobile terminal B as shown in FIG. 2; and

FIG. 5a shows a simplified diagram of a network system according to the prior art; FIG. 5b-h show simplified diagrams of network system according to preferred embodiments of the present invention.

### DESCRIPTION OF THE PREFERRED EMBODIMENTS

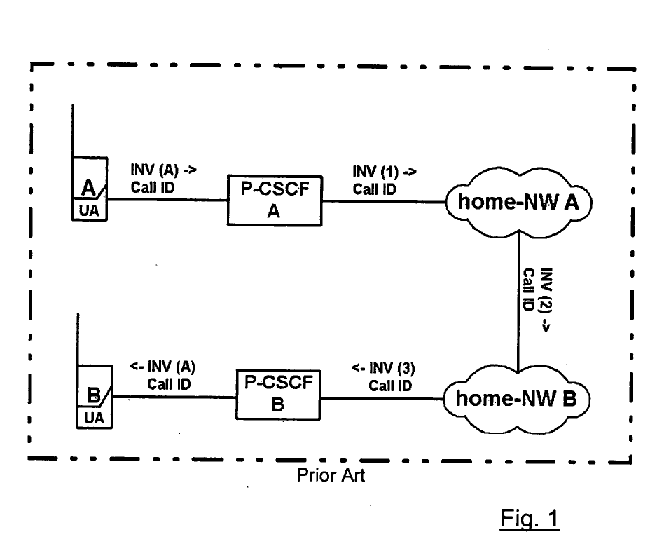

FIG. 1 shows a schematic diagram of a network system according to 3GPP. A first mobile terminal A, namely a calling party, intends to initiate a call with a further mobile terminal B, namely a called party. The mobile terminal A sends a SIP INVITE message, namely INV (A) towards the mobile terminal B via a core particularly comprising home networks home-NW A and home-NW B network.

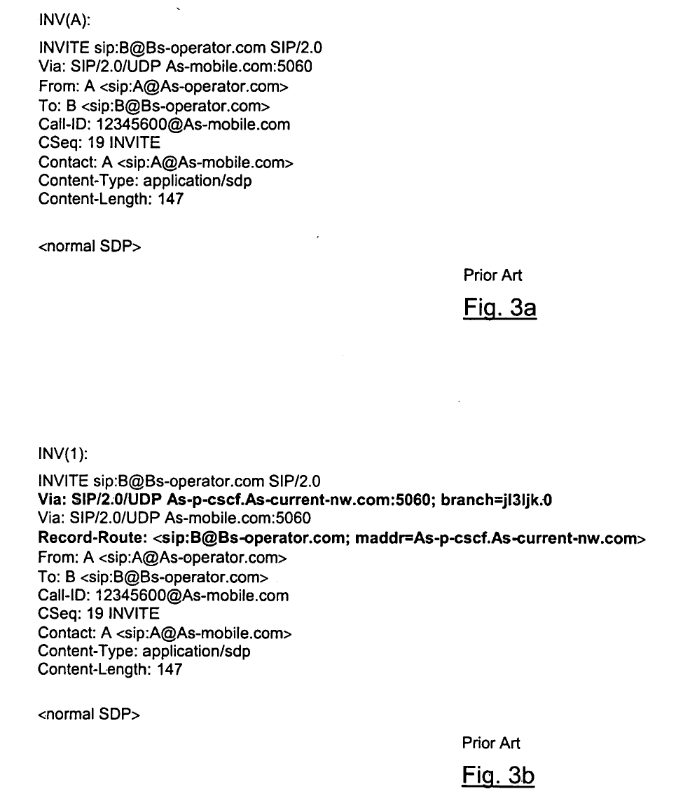

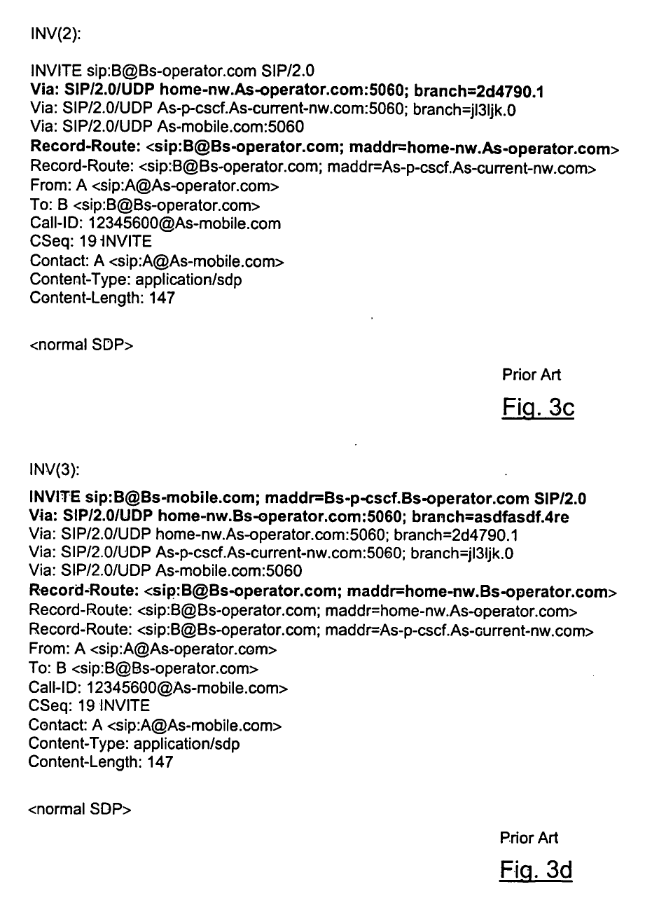

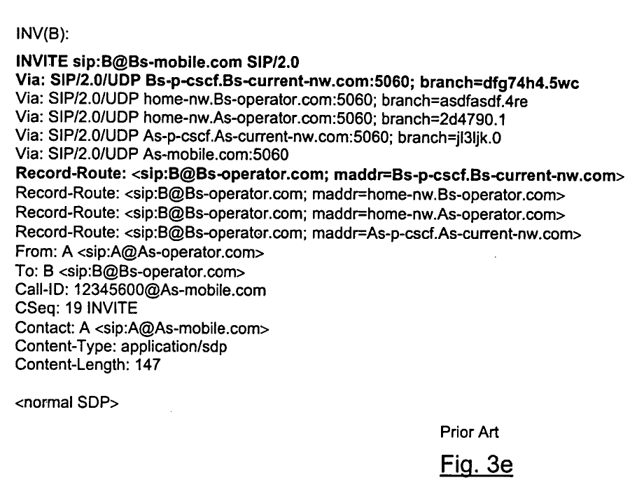

The SIP INVITE message INV (A) is generated by a user agent UA of terminal A thereby including a call identification to the SIP INVITE message INV (A). However, the SIP INVITE message INV (A) is first sent to a proxy call state control function P-CSCF A. This SIP INVITE message INV (A) contains a normal session description including a SIP message header as shown in FIG. 3a comprising in particular one or more Via-header fields, a From-header field, a To-header field and a call identification Call-ID header field.

The Via-header fields indicate a path (or route) through the network taken by the SIP message so far. Thus message loopings can be prevented. Furthermore, it is ensured that reply messages take the same path as the corresponding request messages.

The From-header field indicates the initiator of a SIP (request) message.

The To-header field indicates the desired recipient of a SIP (request) message

The Call-ID identifies a particular invitation.

SIP messages and header fields are described in further details in “SIP: Session Initiation Protocol”, Internet Engineering Task Force, ietf-sip-rfc2543bis-02 by SIP WG Handley/Schulzrinne/Schooler/Rosenberg ACIRI/Columbus U./Caltech/dynamicsoft, Nov. 24, 2000, which is incorporated herein by reference.

SIP INVITE message INV (A) is created by a user agent UA of the mobile terminal A. This message is sent to and received from the P-CSCF A that is constituted by a network element device.

The P-CSCF A evaluates the SIP message header from SIP INVITE message INV (A) and adds a further Via-header field and a Record-Route-header field in order to generate a modified SIP INVITE message INV(1) as shown in FIG. 3b with modifications being indicated by bold typeface.

However, the call identification Call-ID remains unchanged when passing the thus modified SIP INVITE message INV(1) from P-CSCF A to a home network home-NW A. Home-NW A evaluates the SIP message header from SIP INVITE message INV (1) received from P-CSCF A, and adds a further Via-header field and a further Record-Route-header field in order to generate a modified SIP INVITE message INV(2) as shown in FIG. 3c with modifications being indicated by bold typeface. However, again the call identification Call-ID remains unchanged. The thus modified SIP INVITE message is than routed as SIP INVITE message INV (2) to home network home-NW B. Home-NW B analyzes the received SIP INVITE message INV (2), adds a further Via-header field and a further Record-Route-header field and amends the Request-URI by a maddr-field. However, the Call-ID remains unchanged.

The thus modified SIP INVITE message INV (3) as shown in FIG. 3d with modifications being indicated by bold typeface is routed from home-NW B to a further network element, namely proxy call state control function P-CSCF B. P-CSCF B again analyzes the SIP INVITE message INV (3) received from home-NW B and adds a further Via-header field and a further Record-Route-header field as being indicated by bold typeface in FIG. 3e and routes the thus modified SIP INVITE message as INV (B) to mobile terminal B, however, again without changing the call identification Call-ID.

Mobile terminal B comprises a further user agent that receives and processes SIP INVITE message INV (B) and answers with an 200 OK SIP message if the request has succeeded.

It is noted that a CSeq (command sequence) header field remains unchanged in FIG. 3a to 3e, i.e. while routing the SIP INVITE message from mobile terminal A to mobile terminal B via network elements P-CSCF A, home-NW A, home-NW B and P-CSCF B.

A CSeq header field contains the request method, such as INVITE, and a single decimal sequence number, unique within a single call leg. The initial value of the sequence number is substantially arbitrary, however less than 2³¹. Consecutive requests that differ in request method, header or body/payload, but have the same Call-ID conventionally comprise increasing and contiguous sequence numbers.

As described above a SIP interdependency between the mobile terminal A and the mobile terminal B is created enabling the terminals A and B to send SIP messages to each other and to initiate, maintain and terminate a SIP session.

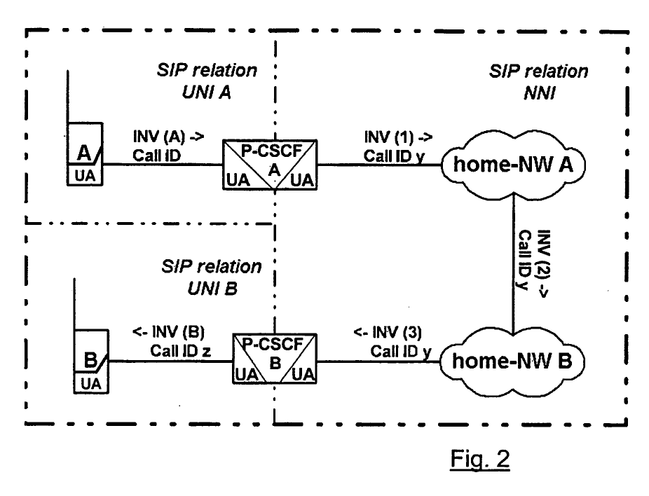

FIG. 2 shows a diagram of a network system according to a preferred embodiment of the invention. Compared with FIG. 1 several modifications have been carried out. However, some of the components shown in FIG. 1 remain unchanged as will be described hereinafter.

A first modification has been carried out to network element P-CSCF A and to network element P-CSCF B. Both network elements are comprising user agents UA that are acting as respective user agents of the mobile terminals A or B from the core network point of view, in particular from the point of view of home-NW A and home-NW B.

Due to this modification of the P-CSCFs the SIP interdependency between mobile terminal A and mobile terminal B is divided into a number of SIP relations, namely a SIP relation that is identified as SIP relation UNI A, i.e. the SIP relation between mobile terminal A and P-CSCF A, a SIP relation UNI B, namely SIP relation between mobile terminal B and P-CSCF B, and a further SIP relation between P-CSCF A an P-CSCF B.

It is noted that the SIP relation between the network element P-CSCF A and the network element P-CSCF B can be further subdivided into further SIP relations.

In the following, an initiation of a SIP session between mobile terminal A and mobile terminal B is described with reference to FIG. 2:

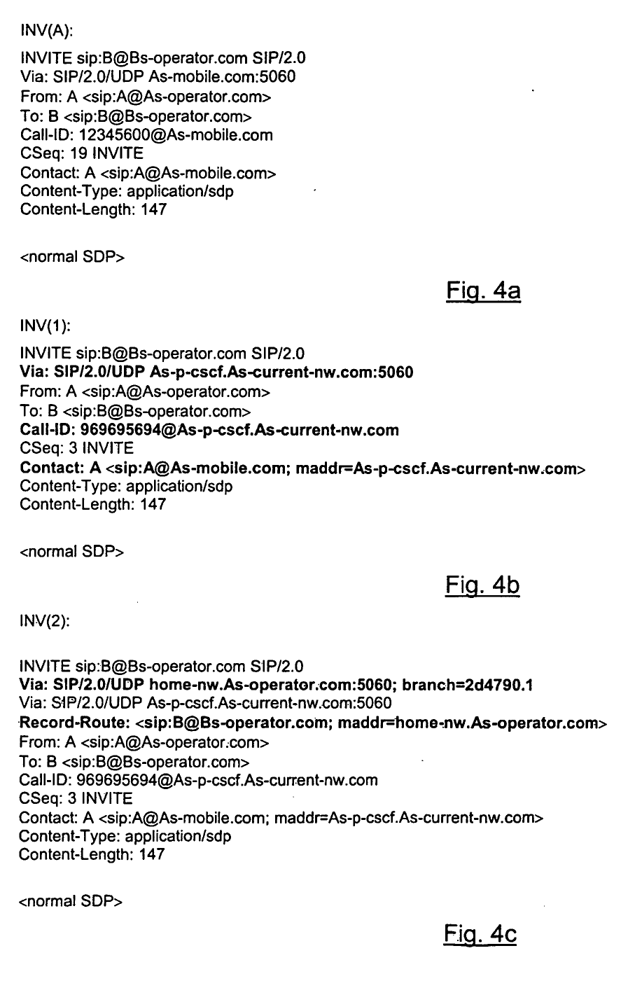

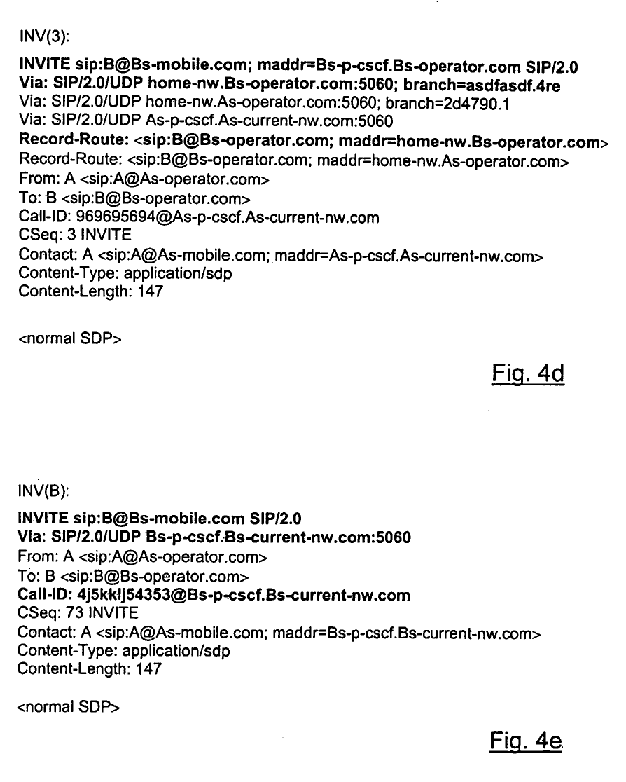

A user agent UA of the mobile terminal A creates an SIP INVITE message INV (A) as shown in FIG. 4a including a first call identification Call-ID x. This SIP INVITE message INV (A) is sent to a user agent UA of the P-CSCF A acting as a user agent server towards the mobile terminal A.

P-CSCF A generates a new SIP INVITE message INV (1) based on the received, thereby in particular creating a new call identification Call-ID y different to call identification Call-ID x of SIP INVITE message INV (A). Thus a new SIP INVITE message INV (1) is created as shown in FIG. 4b with differences being indicated by bold typeface. Besides creating the new Call-ID y, P-CSCF A also creates a new Via-header field that is used instead of the received Via-header field or fields and creates a new Contact-header field based on the received Contact-header field, thereby adding a maddr-parameter.

The thus created new SIP INVITE message INV (1) is sent via the core network to home-NW A which amends this new SIP INVITE message INV (1) by adding a further Via-header field and a Record-Route-header field thus generating an amended SIP INVITE message INV(2) as shown in FIG. 4c with amendments highlighted in bold typeface. Particularly the call identification remains unchanged, i.e. Call-ID y from SIP INVITE message INV (2) is identical to Call-ID y from INV (1).

SIP INVITE message INV (2) is routed to home-NW B that amends the SIP message header again by adding new header fields thus generating an amended SIP INVITE message INV (3) as being indicated in FIG. 4d. In particular the Request-URI is amended by an added maddr-field. Furthermore, a new Via-header field is added as well as a new Record-Route-header field. Particularly the call identification Call-ID y remains unchanged.

SIP INVITE message INV (3) arrives at a user agent UA of P-CSCF B that in turn evaluates the SIP INVITE message INV (3) and based on the evaluation of the SIP INVITE message INV (3) generates a new INVITE message INV (B) as shown in FIG. 4e with modifications indicated in bold typeface. In particular P-CSCF B creates a modified Request-URI, and does not insert previous Via-header fields, Record-Route-headers fields or call identifications Call-ID, but inserts a new Via-header field as well as a new call identification Call-ID z as being indicated in FIG. 2. The thus new generated SIP INVITE message is sent to mobile terminal B, in particular to a user agent UA of mobile terminal B.

It is noted that the CSeq header field only remains unchanged within a SIP relation and alters between different SIP relations, i.e. each SIP relation, SIP relation UNI A, SIP relation NNI, and SIP relation UNI B have different CSeq header fields. Thus, in FIGS. 4b to 4d the CSeq header fields are the same, whereas the CSeq header fields in FIG. 4a as well as in FIG. 4e are different to those of FIGS. 4b to 4d. Furthermore, the values of the sequence numbers of the header fields is arbitrary and not necessarily monotonically increasing since the SIP relations, SIP relation UNI A, SIP relation NNI, and SIP relation UNI B , are in this regard independent.

Although the above routing of a SIP message has been described with reference to a SIP INIVITE message, the same modifications during routing of a SIP message apply to any other type of message, such as ACK, OPTIONS, BYE, CANCEL and REGISTER, as well as extension messages as SUBSCRIBE, NOTIFY, PRACK, COMET, INFO, MESSAGE, and REFER.

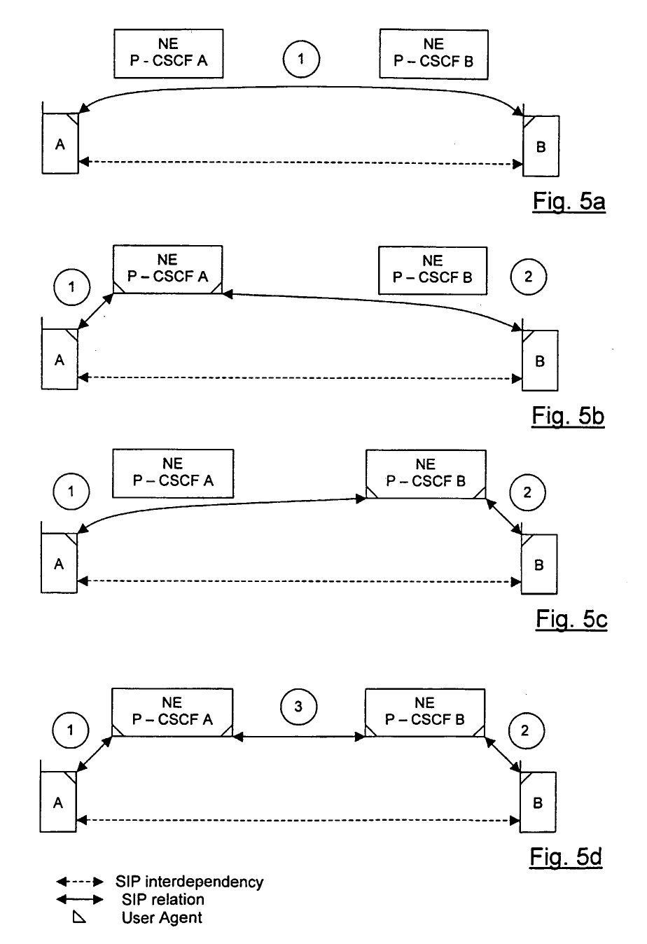

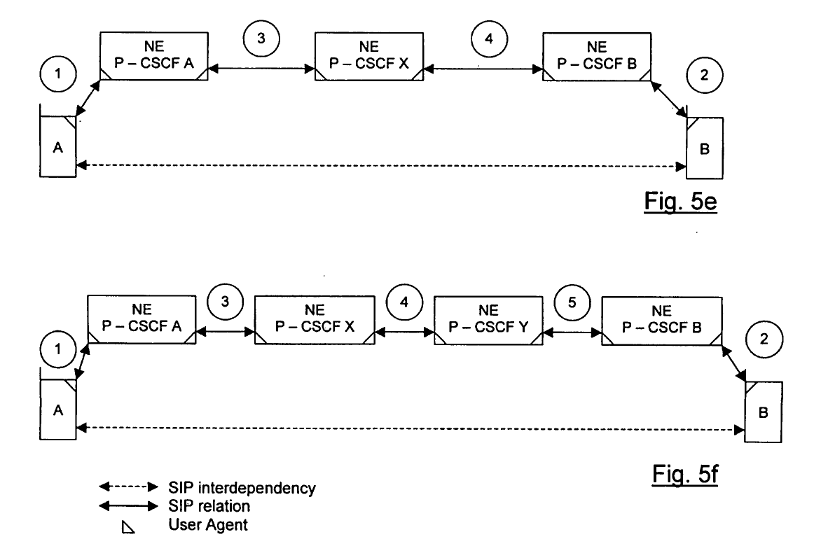

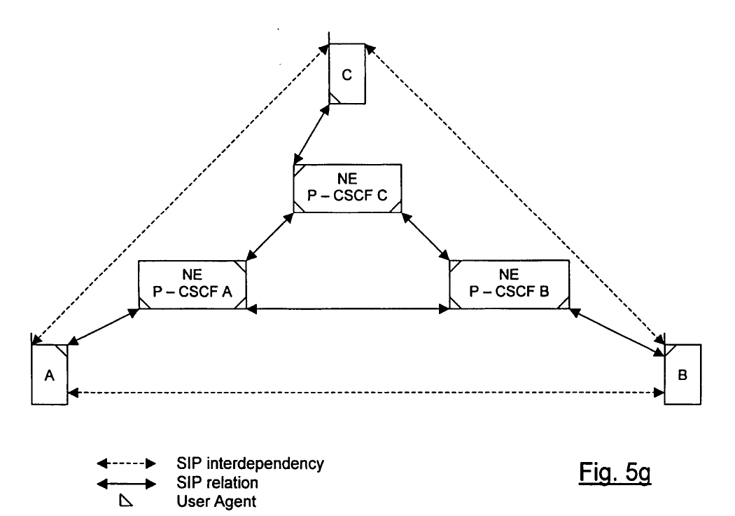

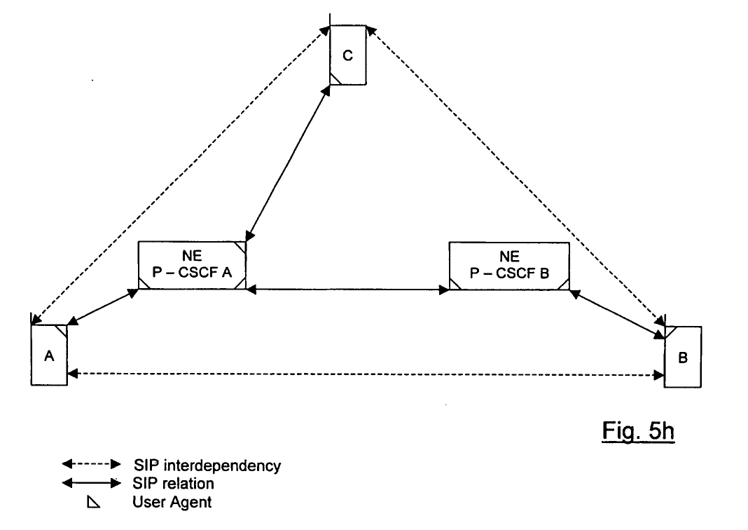

FIGS. 5a-5h show simplified diagrams of network systems comprising at least two network elements NE and at least two terminals A, B or three terminals A, B, C.

FIG. 5a shows a network system according to the prior art whereas FIGS. 5b-5h show network systems according to preferred embodiments of the present invention. In all figures the double arrows with dashed lines indicate SIP interdependencies, double arrows with solid lines indicate SIP relations, and triangles indicate user agents.

In FIG. 5a terminals A and B are in a SIP interdependency. This SIP interdependency is implemented by a single SIP relation between terminal A and terminal B. SIP messages are routed from terminal A via a first network element NE P-CSCF A and via a second network element NE P-CSCF B to terminal B. This situation corresponds to FIG. 1, however in a simplified illustration.

FIG. 5b shows a simplified illustration of a network system quite similar to the system according to FIG. 5a. However, the SIP interdependency between terminal A and terminal B is created by two SIP relations, namely a first SIP relation between terminal A and NE P-CSCF A being currently associated with terminal A and a second SIP relation between terminal B and NE P-CSCF A. NE P-CSCF A is currently associated with terminal A as well with terminal B. However, the SIP relation between terminal B and NE P-CSCF A is routed via NE P-CSCF B. FIG. 5c shows an situation quite similar to the situation of FIG. 5b, however with changed roles between NE P-CSCF A and NE P-CSCF B. The arrangements according to FIG. 5b and FIG. 5c have the advantage of trusted call-ID.

FIG. 5d shows a network system with three SIP relations forming the SIP interdependency between terminal A and B, namely a first SIP relation between terminal A and NE P-CSCF A, a second SIP relation between a terminal B and NE P-CSCF B, and a third SIP relation between NE P-CSCF A and NE P-CSCF B. This situation, corresponds the situation shown in FIG. 2.

FIG. 5e shows a network system similar to the situation shown in FIG. 5d, however, with a further network element NE P-CSCF X in between NE P-CSCF A and NE P-CSCF B. Thus, the SIP interdependency between terminal A and terminal B is created by establishing a consecutive chain of SIP relations between the network elements, namely SIP relation between NE P-CSCF A and NE P-CSCF X and a consecutive SIP relation between NE P-CSCF X and NE P-CSCF B. As result, a consecutive chain of a plurality of SIP relations is established between terminal A and terminal B.

FIG. 5f shows a network system with an elongated chain of SIP relations as a result of a further network element NE P-CSCF Y. It is noted, that further network elements can be inserted elongating the chain of consecutive SIP relations between the terminals A and B.

FIG. 5g shows a network system as a result of combining three times the situation of FIG. 5d as it may occur during conference calls. In FIG. 5g three participants join a session of a conference call between the terminals A, B and C. Each terminal is associated with a network element, terminal A being associated with NE P-CSCF A, terminal B with NE P-CSCF B, and terminal C with NE P-CSCF C. Thus, SIP interdependencies are created between respectively two terminals, namely between A and B, A and C, as well as between B and C.

Even though each terminal is associated with a different network element, this is not necessary, as will be described hereinafter.

FIG. 5h shows a network system quite similar to FIG. 5g with three terminals A, B, and C. However, the network system does not comprise a network element for each of the terminals. Thus, only terminals A and B are associated with different network elements NE P-CSCF A and NE P-CSCF B, whereas terminal C is associated with network element NE P-CSCF A as well. Thus, the SIP interdependency between terminals A and B corresponds to the situation shown in FIG. 5d. The SIP interdependency between terminals B and C corresponds to the situation shown in FIG. 5d as well. However, the SIP interdependency between terminals A and C corresponds substantially to the situation shown in FIG. 5b, whereby just one network element is used for creating the SIP interdependency between terminals A and C.

It is noted, that conference calls can be performed with even more than three terminals and with more than three network elements and thus more than three SIP interdependencies.

The above described embodiments enable hiding internal local network structures from the terminal point of view. Thus the network security is increased. Furthermore, due to the above modifications the call identification for the SIP relation NNI is much more trustful since it is generated by a P-CSCF.

Furthermore, the P-CSCFs are able to issue an SIP BYE message in case the connection between (mobile) terminal and networks get lost. Thus, a session can be released properly in a defined manner.

Furthermore, due to the above concept the enforcing of policy, e.g. a prepaid call has to be released in case of no credit being left, is easier with P-CSCFs then with the mobile terminals, in particular as the P-CSCF is more trustful and more reliable then a mobile terminal. Thus, a session can be released properly in a defined manner.

Furthermore, mid call announcements can be handled substantially independently from the mobile terminals. Thus capacity can be saved on the air Interface and faster switch-overtimes can be realized. Furthermore, retransmission control in User Datagram Protocol (UDP) can be done separately for the air interface and the core network. Thus shorter call setup times are enabled. Furthermore, capacity can be saved on the network-to-network interface.

Furthermore, due to the above described concept the likelihood of exceeding the MTU (Maximum Transfer Unit) is reduced.

According to a further modification retransmission timers are adjusted separately on NNI and UNI. If SIP is used over UDP retransmission timers are set to ensure that SIP messages arrive. In case a reply to a SIP message does not arrive after a certain time, the corresponding SIP message is retransmitted. Typical delays for arrival of SIP messages differ in UNI and NNI, since regularly UNI contains air interface and NNI an interface only in a fixed network. Adjusting the timers separately makes sure that retransmission are only done a kind of locally, not effecting the NNI in case a message is lost on UNI and vice-versa.

In common internet protocol networks there is defined a maximum packet length that can be transmitted without fragmentation, namely the MTU. This maximum packet length is, e.g. in Ethernet, typically 1500 bytes. If fragmentation occurs and fragmented packets arrive out of order, there can be a problem to recompose the packets in the correct order. Also the delay resulting from fragmentation and recomposing the packets is undesirable. Therefore, according to the above embodiment one or more header fields are saved on the network elements, the NNI or UNI depending on the direction of the message routing. The saved header field or fields include in particular the Via, Record-Route-header and/or Route-header fields. Thus, the likelihood of exceeding the MTU is reduced considerably.

The following further modifications are preferred:

Preferably the P-CSCFs adjust the session description protocol (SDP) in order to increase the number of successful calls. This is advantageously as the mobile terminal might not necessary know enough about quality of service and media capabilities of the network. For example, the P-CSCF and the mobile terminals can negotiate the media route on the UNI separately from the NNI media route. Thereby, the P-CSCF takes care that the data streams are connected correctly.

Furthermore, it is preferred to carry out an end-to-end encryption of SIP message bodies/payloads and zero or more of the header fields.

If H.323 is used on the UNI it can be translated to SIP at the P-CSCF. From the NNI point of view there is no difference, whether the mobile terminal uses H.323 or SIP. A similar P-CSCF could be used as public switched telephone networks (PSTN) gateway, i.e. a PSTN-SIP gateway. Thereby also announcements, answering machines, or in general non-SIP terminals are interconnectable in a similar way.

Furthermore, it is proposed to use SIP over transmission control protocol (TCP) in the UNI. A TCP connection between the mobile terminal and P-CSCF is then established at registration time and used for all the signaling traffic.

It is noted that the present invention is not restricted to the preferred embodiments described above, in particular any kind of SIP message besides INVITE messages can be transmitted and routed via networks. Furthermore, the present invention can be implemented in any fixed or wireless network environment using any kind of session initiation protocols in packet switch networks as well as in circuit switched networks as well as in combined packets switched and circuit switched networks, in particular in UMTS terminals according to the 3GPP and in set-top-boxes. The messages can be of various types and the number of SIP relations in particular between the network elements can be one or larger than one. The preferred embodiment may thus vary within the scope of the attached claims.

1. A method for controlling sessions between terminals in a network by means of a session initiation protocol (SIP) being defined to initiate, maintain and terminate sessions with said terminals, thereby creating a session initiation protocol (SIP) interdependency between a first terminal and a second terminal,
said session initiation protocol (SIP) interdependency being created by:
a) establishing a first session initiation protocol relation (SIP relation) between said first terminal and a network element currently associated with said first terminal, and
b) establishing a second session initiation protocol relation (SIP relation) between said second terminal and a network element currently associated with said second terminal.

2. A method according to claim 1, wherein said network element currently associated with said first terminal being the same as said network element currently associated with said second terminal.

3. A method according to claim 1, wherein said network element currently associated with said first terminal being a first network element and said network element currently associated with said second terminal being a second network element, first and second network elements being different network elements.

4. A method according to claim 3, wherein said session initiation protocol interdependency being further created by establishing a third session initiation protocol relation (SIP relation) between said first network element and said second network element.

5. A method according to claim 3, wherein said session initiation protocol (SIP) interdependency being further created by establishing a consecutive chain of further session initiation protocol relations (SIP relation) between said first network element (P-CSCF A), one or more further network elements and said second network element, namely at least
a further session initiation protocol relation (SIP relation) between said first network element and a further network element,
a further session initiation protocol relation (SIP relation) between said second network element (P-CSCF B) and a further network element, and
in case of more than one further network elements one or more further session initiation protocol relations (SIP relation) between two further network elements, respectively.

6. A method according to claim 5, wherein one or more further terminals participate in a session, thereby creating session initiation protocol (SIP) interdependencies between each of said terminals, each of said interdependency being created similar to said interdependency between said first terminal (A) and said second terminal.

7. A method according to claim 6, wherein a network element currently associated with a terminal is acting as a user agent towards a user agent of said associated terminal and as a user agent towards the network.

8. A method according to claim 5, wherein
a) said first network element is acting as a user agent towards a user agent of said first terminal and as a user agent towards the network and
b) said second network element is acting as a user agent towards a user agent of said second terminal and as a user agent towards the network.

9. A method according to claim 8, wherein each of said user agents is acting as a user agent server towards the respective terminal and as a user agent client towards said network and/or acting as a user agent client towards the respective terminal and as a user agent server towards said network.

10. A method according to claim 8, wherein
a) said first session initiation protocol relation (SIP relation) is a user-to network interface on session initiation protocol (SIP) level between said first terminal (A) and said first network element,
b) said second session initiation protocol relation (SIP relation) is a further user-to-network interface on session initiation protocol (SIP) level between said second terminal and said second network element; and
c) said third session initiation protocol relation (SIP relation) is a network-to-network interface on session initiation protocol level between said first network element and said second network element.

11. A method according to claim 8, wherein said user agents of said network elements are acting as respective user agents of said terminals from the network point of view.

12. A method according to claim 8, wherein said network elements are creating call identifications of session initiation protocol (SIP) messages, thus
a) a first call identification is used in said first session initiation protocol relation (SIP relation),
b) a second call identification is used in said second session initiation protocol relation (SIP relation), and
c) a third call identification is used in said third session initiation protocol relation (SIP relation),
d) wherein said first and third call identifications are different from each other and
e) wherein said second and third call identifications are different from each other.

13. A method according to claim 12, wherein said first and second call identifications are different from each other.

14. A method according to claim 8, wherein a network element generates a session initiation protocol (SIP) message based on received session initiation protocol (SIP) message without Via-header fields from said received session initiation protocol message (SIP) message but with a new Via-header field from the respective network element before sending said generated session initiation protocol (SIP) message.

15. A method according to claim 8, wherein a network element generates a session initiation protocol (SIP) message based on a received session initiation protocol message (SIP) message without Route-header fields and/or Record-Route-header fields from said received session initiation protocol (SIP) message before sending said generated session initiation protocol (SIP) message.

16. A method according to claim 8, wherein each of said network elements comprise call state control function, in particular proxy call state control function, serving call state control function and/or interrogating call state control function, and/or application server functionality.

17. A method according to claim 8, wherein said user agents of said network elements are acting as back-to-back to user agents.

18. A system comprising a one or more network elements and terminals, said system being designed for controlling sessions between said terminals by means of a session initiation protocol (SIP) being defined to initiate, maintain and terminate sessions with said terminals, said system further comprising a session initiation protocol (SIP) interdependency between a first terminal and a second terminal,
said session initiation protocol (SIP) interdependency comprising:
a) a first session initiation protocol relation (SIP relation) between said first terminal and a network element currently associated with said first terminal, and
b) a second session initiation protocol relation (SIP relation) between said second terminal and a network element currently associated with said second terminal.

19. A system according to claim 18, wherein said session initiation protocol (SIP) interdependency further comprising a third session initiation protocol relation (SIP relation) between said first network element and said second network element.

20. A system according to claim 18 or 19 comprising means for performing a method according to any of claims 1 to 17.

21. A network element device for use in a system according to any of claims 18 to 20 and for controlling sessions between terminals in a network by means of session initiation protocol (SIP) being defined to initiate, maintain and terminate sessions with said terminals and creating a session initiation protocol (SIP) interdependency between a first terminal and a second terminal, said network element device comprising:
a) first means for establishing a first session initiation protocol relation with said first terminal or a further network element device, and
b) second means (UA) for establishing a second initiation protocol relation (SIP relation) with a second terminal or a still further network element device.

22. A network element device according to claim 21, wherein said first and second means are user agents.

23. A network element device according to claim 21 or 22 comprising means for performing a method according to any of claims 1 to 19.
